(19) United States
(12) Patent Application Publication
(10) Pub. No.: US 2003/0035547 A1
(43) Pub. Date: Feb. 20, 2003

(54) Server with multiple encryption libraries

(76) Inventor: John Newton, Oxford (GB)

Correspondence Address: C. Douglas McDonald, Esq., Carlton Fields, et al., P.O. Box 3239, Tampa, FL, 33601-3239, US

(21) Appl. No.: 09/820,216

(22) Filed: Mar. 27, 2001

(51) Int. Cl. H04L 9/00

(52) U.S. Cl. 380/279; 713/155

(57) ABSTRACT

A system, method and computer program product are provided for utilizing encrypter hardware with a server. Initially, an encryption layer module is run on a server. Such encryption layer module is capable of selecting an encryption algorithm from a library of encryption algorithms. In operation, the encryption layer module offloads a host processor of the server by executing the selected encryption algorithm using dedicated encrypter hardware.

### FIELD OF THE INVENTION

The present invention relates to encryption and more particularly to servers with encryption capabilities.

### BACKGROUND OF THE INVENTION

Computer transactions have become more and more mainstream over the last 20 years, starting with banking and telephone networks and progressing through the Internet explosion currently going today. Computers have pervaded everyday life with the advent of the information age, and with this mainstreaming, individual security and privacy concerns have grown as well. As a result, the needs for ever more complex encryption methods arise which in turn require more processing power.

Apache web server is one of the most popular web servers in existence. The Apache Project is a collaborative software development effort aimed at creating a robust, commercial-grade, featureful, and freely-available source code implementation of an HTTP (web) server. The project is jointly managed by a group of volunteers located around the world, using the Internet and the Web to communicate, plan, and develop the server and its related documentation. These volunteers are known as the Apache Group. In addition, hundreds of users have contributed ideas, code, and documentation to the project.

The Apache web sever is a program that can handle HTML requests from a network. To respond to SHTML (Secure HTML) requests from a network, Apache must use a module called OpenSSL.

Secure Sockets Layer (SSL) technology, is the industry-standard method for protecting web communications developed by Netscape® Communications. The SSL security protocol provides data encryption, server authentication, message integrity, and optional client authentication for a TCP/IP connection.

SSL comes in two strengths, 40-bit and 128-bit, which refer to the length of the “session key” generated by every encrypted transaction. The longer the key, the more difficult it is to break the encryption code. Most browser's support 40-bit SSL sessions, and the latest browsers, including Netscape® Communicator® 4.0, enable users to encrypt transactions in 128-bit sessions—trillions of times stronger than 40-bit sessions.

Currently, the Apache web server performs all encryption processes (i.e. SSL) using a host processor. Since the Apache web server project is open source, the use of the host processor enables developers to tailor the program for their own needs. Unfortunately, this is often done at the expense of a loss of performance inherent to the use of software and general-use host processors.

### SUMMARY OF THE INVENTION

A system, method and computer program product are provided for utilizing encrypter hardware with a server. Initially, an encryption layer module is run on a server. Such encryption layer module is capable of selecting an encryption algorithm from a library of encryption algorithms. In operation, the encryption layer module offloads a host processor of the server by executing the selected encryption algorithm using dedicated encrypter hardware.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 illustrates a preferred embodiment of the present invention where the hardware environment set forth in FIG. 1 is configured to be an Apache web server in a Unix environment;

FIG. 3 illustrates a particular method of modifying a web server such as an Apache web server for the purpose of offloading the host processor thereof;

FIG. 4 shows that SSL runs above TCP/IP and below high-level application protocols;

FIG. 5 illustrates how a server authenticates a server's identity; and

FIG. 6 illustrates how a server authenticates a client certificate.

### DETAILED DESCRIPTION OF THE PREFERRED EMBODIMENTS

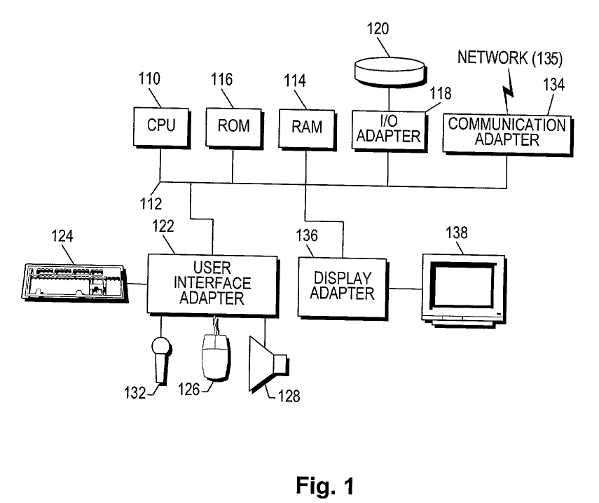

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

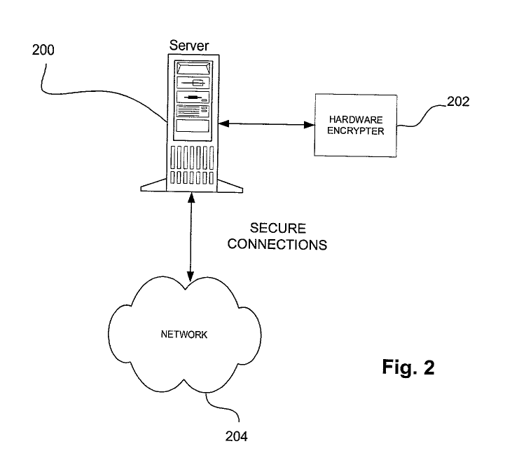

FIG. 2 illustrates a preferred embodiment of the present invention where the hardware environment set forth in FIG. 1 may be configured to be an Apache web server 200 in a Unix environment. It should be noted, however, that the principles of the present invention may be applied in the context of other types of web servers per the desires of the user. Moreover, any other operating system environment may be utilized.

Configuring a server to Apache specifications is well known, and easily accomplished by those of ordinary skill in the art. In one embodiment of the present invention, an Apache, OpenSSL, ModSSL, and Shared Memory Manager module are installed on the Apache web server. Once configured in accordance with the prior art, the Apache web server performs all encryption processes (i.e. SSL) using a host processor.

The present invention includes a technique for modifying a web server such as an Apache web server for the purpose of offloading the host processor thereof. This is accomplished by utilizing dedicated encrypter hardware 202 with the server 200. In accordance with one embodiment of the present invention, a Celoxica Ltd DES hardware encrypter may be utilized. It should be understood that the principles of the present invention may be used to configure web servers to utilize other types of hardware encrypters. To this end, improved performance is afforded, and the server is equipped with the ability to handle more secure connections than would otherwise be possible utilizing a network 204, i.e. the Internet.

In one embodiment, the hardware encrypter may be implemented using a field programmable gate array (FPGA). Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reProgrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's' may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modern FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.™.. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Limited. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Additional information may also be found in a co-pending application entitled “SYSTEM, METHOD AND ARTICLE OF MANUFACTURE FOR PARAMETERIZED EXPRESSION LIBRARIES” which was filed Jan. 29, 2001 under Ser. No. 09/772,671, and which is incorporated herein by reference in its entirety.

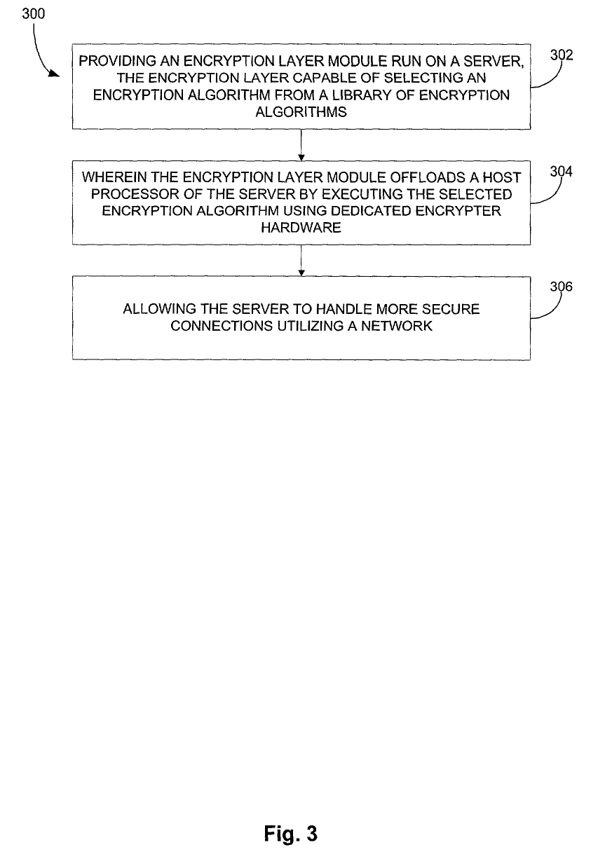

FIG. 3 illustrates a particular method 300 of modifying a web server such as an Apache web server for the purpose of offloading the host processor thereof. In operation 302, an encryption layer module is provided on the server to execute a selected one of a plurality of encryption algorithms.

While multiple sample encryption algorithms are set forth hereinbelow, it should be noted that the encryption layer module may be used to manually or automatically select between any one of numerous encryption algorithms in a library file. Such algorithm may be transmitted from the file utilizing a network. By this design, a server may be adapted to meet any particular encryption need.

As yet another option, parameterized libraries may be used to facilitate the creation of custom versions of an encryption algorithm that could meet the requirements of a specific situation. Additional information regarding parameterized libraries may be found in the co-pending application mentioned hereinabove entitled “SYSTEM, METHOD AND ARTICLE OF MANUFACTURE FOR PARAMETERIZED EXPRESSION LIBRARIES”.

In one exemplary embodiment, the encryption layer module may be modified to execute the selected encryption algorithm(s). In such embodiment, operation 302 may involve the configuration of the Apache web server with one SSL secured host. The cipher suite may be fixed to DES-CBC3-SHA. Table 1 illustrates an exemplary configuration script.

TABLE 1

##
## httpd.conf -- Apache HTTP server configuration file
##
ServerName put_server name here
ServerType standalone
ServerAdmin administrator@domain.com
User nobody
Group nobody
Port 443
Listen 443
Listen 80
KeepAlive 0
KeepAliveTimeOut 0
MaxClients 256
SendBufferSize 131072
SSLEngine on
SSLVerifyClient 0
SSLVerifyDepth 10
SSLCipherSuite DES-CBC3-SHA
SSLCertificateKeyFile/usr/local/openss1-
0.9.4/apps/server.key
SSLCertificateFile/usr/local/openss1-
0.9.4/apps/server.crt
SSLCACertificateFile/usr/local/openss1-
0.9.4/apps/ca.crt
SSLSessionCache
dbm:/usr/local/apache/logs/ssl_gcache_data
SSLSessionCache
shm:/usr/local/apache/logs/ssl_gcache_data (512000)
DocumentRoot/usr/local/apache/htdocs
TransferLog/usr/local/apache/logs/access.log
SSLLog/usr/local/apache/logs/ssl.log
ErrorLog/usr/local/apache/logs/error.log
<VirtualHost put_serve_name_here:80>

SSLEngine off
Port 80
DocumentRoot/usr/local/apache/ht docs
TransferLog/usr/local/apache/logs/naccess.log
ErrorLog/usr/local/apache/logs/n error.log

</VirtualHost>

There are two important files when enabling a hardware encrypter for the Apache web server. The files can be found in the OpenSSL source code in the directory/crypto/des. One file, “des_enc.c,” performs all the DES encryption on the host computer. Specifically, the function “des_ede3_cbc_encrypt( )” needs modifying so that it calls a hardware encrypter such as the Celoxica Ltd DES Encrypter.

The file “des.h” contains all the external function prototypes for the DES library. It also contains the key schedule structure (des_ks_struct) which requires modification. Table 2 illustrates a full listing of both OF the foregoing files, as modified.

TABLE 2
#include <pp1000.h>
#define LOADKEY (a,b,c,d) ( (a << 24) | (b << 16) | (c << 8) | (d) )
int pp1000_initialise_flag = 0;
PP1000_HANDLE PP1000_Handle;
PP1000_STATUS PP1000_Status;
char PP1000_Status_Buffer[1024];
unsigned long int *PP1000_Bank0;
unsigned long int *PP1000_Bank1;
unsigned long int *PP1000_Bank2;
unsigned long int *PP1000_Bank3;
void initialise_pp1000( void )
{

PP1000OpenFirstCard( &PP1000_Handle );
PP1000StatusToString(PP1000_Status,
PP1000_Status_Buffer,1024);
printf(“PP1000OpenFirstCard PP1000 Return Status =

%s\n”,PP1000_Status_Buffer);

PP1000_Status = PPl000ConfigureFromFile( PP1000_Handle,

“/usr/local/apache/bin/des.bit”);

PP1000StatusToString(PP1000_Status,
PP1000_Status_Buffer,1024);
printf(“PP1000ConfigureFromFile PP1000 Return Status =

%s\n”,PP1000_Status_Buffer);

PP1000_Status =
PP1000SetClockRate( PP1000 Handle, PP10000_MCLK,

75000000 );

PP1000StatusToString(PP1000_Status,
PP1000_Status_Buffer,1024);
printf(“PP1000SetClockRate PP1000 Return Status =

%s\n”,PP1000_Status_Buffer);

PP1000_Status = PP1000SetTimeout( PP1000_Handle,

PP1000_TIMEOUT_INFINITE );

PP1000StatusToString(PP1000_Status,
PP1000_Status_Buffer,1024);
printf(“PP1000SetTimeout PP1000 Return Status =

%s\n”,PPl000_Status_Buffer);

PP1000_Bank0 = ( unsigned long int* ) malloc (

1024*1024*2*sizeof (unsigned char) );

PP1000_Bank1 = ( unsigned long int* ) malloc (

1024*1024*2*sizeof (unsigned char) );

PP1000_Bank2 = ( unsigned long int* ) malloc (

1024*1024*2*sizeof(unsigned char) );

PP10000_Bank3 = ( unsigned long int* ) malloc (

1024*1024*2*sizeof (unsigned char) );

if ( (PP1000_Bank0 ==
NULL) | (PP1000_Bank1 == NULL) (PP1000_Bank2

== NULL) | (PP1000_Bank3 == NULL )

{
printf(“des_enc.c des_encrypt3( ) CRITICAL ERROR,
could not allocate

memory, aborting RC1000 Encrypting\n”);

}

}
void des_ede3_cbc_encrypt (const unsigned char *input, unsigned char
*output,

long length, des_key_schedule ks1, des_key_schedule ks2,
des_key_schedule ks3, des_cblock *ivec, int enc)

{

register DES_LONG tin0,tin1;
register DES_LONG tout0,tout1,xor0,xor1;
register const unsigned char *in;
unsigned char *out;
register long l=length;
DES_LONG tin[2];
unsigned char *iv;
PP1000_CHANNEL PP1000 _Channel;
unsigned char PP1000_StatusValue;
unsigned long int LengthCounter;
unsigned long int Counter;
DES_LONG Key1[2], Key2[2],Key3[2];
if (pp1000_initialise_flag == 0)
{
initialise_pp1000( );
pp1000_initialise_flag=1;
}
in=input;
out=output;
iv = &(*ivec) [0];
if (enc)
{
// Save the first key
PP1000_Bank0[0×0000]=( unsigned long int )
LOADKEY(ksl[0].ks.cblock[0],ks1[0].ks.cblock[1],
ks1[0].ks.cblock[2],

ks1[0].ks.cblock[3]);

PP1000_Bank1[0×0000]=( unsigned long int )
LOADKEY(ks1[0].ks.cblock[4],ks1[0].ks.cblock[5],
ks1[0].ks.cblock[6],

ks1[0].ks.cblock[7]);

// Save the data length
LengthCounter = length>>3;
PP1000_Bank2[0×0000] = ( unsigned long int )LengthCounter;
printf(“Data Length = %li\n”,length);
// Save the second key
PP1000_Bank0[0×0001] = ( unsigned long int )
LOADKEY(ks2[0].ks.cblock[0],ks2[0].ks.cblock[1],
ks2[0].ks.cblock[2],

ks2[0].ks.cblock[3]);

PP1000_Bank1[0×0001] = ( unsigned long int )
LOADKEY(ks2[0].ks.cblock[4],ks2[0].ks.cblock[5],
ks2[0].ks.cblock[6]

ks2[0].ks.cblock[7])

// Save the third key
PP1000_Bank2[0×0001] = ( unsigned long int )
LOADKEY(ks3[0].ks.cblock[0]ks3[0].ks.cblock[1],
ks3[0].ks.cblock[2],

ks3[0].ks.cblock[3]);

PP1000_Bank3[0×0001] = ( unsigned long int )
LOADKEY(ks3[0].ks.cblock[4],ks3[0].ks.cblock[5],
ks3[0].ks.cblock[6],

ks3[0].ks.cblock[7])

c21(iv,tout0); // Convert the data to a long
c21(iv,tout1); // Convert the data to a long
// Save the last encrypted piece of data to be XORed with the

first encrypted result

PP1000_Bank2[0×0002] ( unsigned long int ) (tout0);
PP1000_Bank3 [0×0002] ( unsigned long int ) (tout1);
// Assemble the data
for (1−=8, Counter = 0; 1>=0; 1−=8, Counter++)
{
c21 (in, tin0) ; //tin0=in
c21(in,tin1) ; //tin1=in
PP1000_Bank0[0×0002+Counter] = ( unsigned long int

) (tin0)

PP1000_Bank1[0×0002+Counter] = ( unsigned long int

) (tin1);

// Software DES encrypter
// tin0ˆ =tout0;
//tin1ˆ =tout1;
//tin[0]=tin0;
//tin[1]=tin1;
//des_encrypt3((DES_LONG *)tin,ks1,ks2,ks3);
//tout0=tin[0];
//tout1=tin[1];
//if (Counter < 10)
// printf (“Data from original function %1i = %081x-

%081x\n”,Counter, tout0, tout1);

//12c (tout0,out);
//12c (tout1,out);
}
// Request all the memory banks
PP1000_Status =
PP1000RequestMemoryBank( PP1000_Handle, 0×F );
if ( PP1000_Status != PP1000_SUCCESS){
printf(“An error was returned when perfoming and RC1000
operation. Aborting PP1000 encoding (Request Memory Banks
1)\n”);
goto AbortRC1000Encrypt;}
// Set up first DMA Channel for tranferring bank 0
PP1000_Status = PP1000SetupDMAChannel(
PP1000_Handle,
PP1000_Bank0,
0,
((LengthCounter+4) *4)
PP1000_PCI2LOCAL,
&PP1000_Channel );
if ( PP1000_Status != PP1000_SUCCESS){
printf(“An error was returned when perfoming and RC1000
operation. Aborting PP1000 encoding (SetupDMAChannel 2)\n”);
goto AbortRC1000Encrypt;}
// Do DMA
PP1000_Status = PP1000DoDMA( PP1000_Channel );
if ( PP1000_Status != PP1000_SUCCESS){
printf(“An error was returned when perfoming and RC1000
operation. Aborting PP1000 encoding (DoDMA 3)\n”);
goto AbortRC1000Encrypt;}
// Close DMA Channel
PP1000_Status = PP1000CloseDMAChannel( PP1000_Channel );
if ( PP1000_Status != PP1000_SUCCESS){
printf(“An error was returned when perfoming and RC1000
operation. Aborting PP1000 encoding (CloseDMA 4)\n”);
goto AbortRC1000Encrypt;}
// Set up first DMA Channel for tranferring bank 1
PP1000_Status =PP1000SetupDMAChannel(
PP1000_Handle,
PP1000_Bank1,
0×200000,
((LengthCounter+4) *4),
PP1000_PCI2LOCAL,
&PP1000_Channel );
if ( PP1000_Status != PP1000_SUCCESS){
printf (“An error was returned when perfoming and RC1000
operation. Aborting PP1000 encoding (SetupDMAChannel 5)\n”);
goto AbortRC1000Encrypt;}
// Do DMA
PP1000_Status PP1000DoDMA( PP1000_Channel );
if ( PP1000_Status != PP100 0_SUCCESS){
printf (“An error was returned when perfoming and RC1000

operation. Aborting PP1000 encoding (DoDMA 6)\n”);

goto AbortRC1000Encrypt;}

// Close DMA Channel
PP1000_Status = PP1000CloseDMAChannel( PP1000_Channel );
if ( PP1000_Status != PP1000_SUCCESS){

printf (“An error was returned when performing and RC1000

operation. Aborting PP1000 encoding (CloseDMA 7)\n”);

goto AbortRC1000Encrypt; }
// Set up first DMA Channel for tranferring bank 2
PP1000_Status = PP1000SetupDMAChannel(
PP1000_Handle,
PP1000_Bank2,
0×400000,
48,
PP1000_PCI2LOCAL,
&PP1000_Channel );
if ( PP1000_Status != PP1000_SUCCESS){
printf(“An error was returned when perfoming and RC1000

operation. Aborting PP1000 encoding (SetupDMAChannel 8) \n”);

goto AbortRC1000Encrypt; }

// Do DMA
PP1000_Status = PP1000DoDMA ( PP1000_Channel );
if (PP1000_Status != PP1000 SUCCESS){

printf (“An error was returned when perfoming and RC1000
operation. Aborting PP1000 encoding (DoDMA 9) \n”);
goto AbortRC1000Encrypt;}

// Close DMA Channel
PP1000_Status = PP1000CloseDMAChannel( PP1000_Channel );
if ( PP1000_Status != PP1000 SUCCESS){
printf(“An error was returned when perfoming and RC1000
operation. Aborting PP1000 encoding (CloseDMAChannel
10) \n”);
goto AbortRC1000Encrypt;}
// Set up first DMA Channel for tranferring bank 3
PP1000_Status = PP1000SetupDMAChannel(

PP1000_Handle,
PP1000_Bank3,
0×600000,
48,
PP1000_PCI2LOCAL,
&PP1000_Channel );
if ( PP1000_Status != PP1000_SUCCESS){
printf(“An error was returned when perfoming and RC1000

operation. Aborting PP1000 encoding (SetupDMAChannel 11) \n”);

goto AbortRC1000Encrypt;}

// Do DMA
PP1000_Status = PP1000DoDMA( PP1000_Channel );
if ( PP1000_Status != PP100 0_SUCCESS){

printf(“An error was returned when pertoming and RC1000

operation. Aborting PP1000 encoding (DoDMA 12) \n”);

goto AbortRC1000Encrypt;}

// Close DMA Channel
PP1000_Status = PP1000CloseDMAChannel( PP1000_Channel );
if ( PP1000_Status PP100 0_SUCCESS){

printf (“An error was returned when perfoming and RC1000

operation. Aborting PP1000 encoding (CloseDMA 13)\n”);

goto AbortRC100QEncrypt; }

// Free the memory banks
PP1000_Status = PP1000ReleaseMemoryBank ( PP1000_Handle, 0×F );
if ( PP1000_Status != PP1000_SUCCESS){

printf (“An error was returned when perfoming and RC1000
operation. Aborting PP1000 encoding (Release Memory Banks
14\n”)
goto AbortRC1000Encrypt;}
// Request FPGA do DES Encode
PP1000_Status = PP1000WriteControl( PP1000_Handle, 0 );
if ( PP1000_Status != PP1000 SUCCESS){
printf(“An error was returned when perfoming and RC1000
operation. Aborting PP1000 encoding (WriteControl 15)\n”);
goto AbortRC1000Encrypt;}
// Wait for FPGA Signal Done
PP1000_Status = PP1000ReadStatus( PP1000_Handle,

&PP1000_StatusValue );

if ( PP1000_Status != PP1000_SUCCESS){
printf(“An error was returned when perfoming and RC1000
operation. Aborting PP1000 encoding (ReadStatus 16)\n”);
goto AbortRC1000Encrypt;}
// Request the memory banks
PP1000_Status =
PP1000RequestMemoryBank( PP1000_Handle, 0×F );
if ( PP1000_Status != PP100 0_SUCCESS){
printf(“An error was returned when perfoming and RC1000
operation. Aborting PP1000 encoding (Request Memory Bank
17) \n”);
goto AbortRC1000Encrypt;}
// Set up first DMA Channel for transferring bank 2 which

contains the encrypted data

PP1000_Status = PP1000SetupDMAchannel(
PP1000_Handle,
PP1000_Bank2,
0×400000,
((LengthCounter+4) *4),
PP1000_LOCAL2PCI,
&PP1000_Channel );
if ( PP1000_Status != PP1000_SUCCESS){
printf(“An error was returned when perfoming and RC1000
operation. Aborting PP1000 encoding (SetupDMA 18)\n”);
goto AbortRC1000Encrypt;}
// Do DMA
PP1000_Status = PP1000DoDMA( PP1000_Channel );
if ( PP1000_Status != PP1000_SUCCESS){
printf(“An error was returned when perfoming and RC1000
operation. Aborting PP1000 encoding (DoDMA 19)\n”);
goto AbortRC1000Encrypt;}
// Close DMA Channel
PP1000_Status = PP1000CloseDMAChannel( PP1000_Channel );
if ( PP1000_Status != PP1000_SUCCESS){
printf(“An error was returned when perfoming and RC1000
operation. Aborting PP1000 encoding (CloseDMA 20)\n”);
goto AbortRC1000Encrypt;}
// Set up first DMA Channel for transferring bank 3 which

contains the encrypted data

PP1000_Status = PP1000SetupDMAChannel(
PP1000_Handle,
PP1000_Bank3,
0×600000,
((LengthCounter+4) *4),
PP1000_LOCAL2PCI,
&PP1000_Channel );
if ( PP1000_Status != PP1000_SUCCESS){
printf(“An error was returned when perfoming and RC1000
operation. Aborting PP1000 encoding (SetupDMA 21)\n”);
goto AbortRC1000Encrypt;}
// Do DMA
PP1000_Status =PP1000DoDMA( PP1000_Channel );
if ( PP1000_Status != PP1000_SUCCESS){
printf(“An error was returned when perfoming and RC1000
operation. Aborting PP1000 encoding (DoDMA 22)\n”);
goto AbortRC1000Encrypt;}
// Close DMA Channel
PP1000_Status = PP1000CloseDMAChannel( PP1000_Channel );
if ( PP1000_Status != PP1000_SUCCESS){
printf(“An error was returned when perfoming and RC1000
operation. Aborting PP1000 encoding (CloseDMA 23)\n”);
goto AbortRC1000Encrypt;}
// Free the memory Banks
PP1000_Status =
PP1000ReleaseMemoryBank( PP1000_Handle, 0×F );
if ( PP1000_Status != PP1000_SUCCESS){
printf(“An error was returned when perfoming
and RC1000 operation. Aborting PP1000
encoding (Release memory bank (24)\n”);
goto AbortRC1000Encrypt;}
AbortRC1000Encrypt:
if ( PP1000_Status != PP1000_SUCCESS ){
PP1000StatusToString ( PP1000_Status,

PP1000_Status_Buffer, 1024 );

printf( “PP1000 Error =%s\n”, PP1000_Status_Buffer );}

for (Counter = 0; Counter < LengthCounter ; Counter ++)

{
tout0=PP1000_Bank2[0×0000+Counter];
tout1=PP1000_Bank3[0×0000+Counter];
12c(tout0,out);
12c(tout1,out);
}

if (1 != −8)
{

c21n(in,tin0,tin1,1+8);
tin0ˆ =tout1;
tin1ˆ =tout1;
tin[0]=tin0;
tin[1]=tin1;
des_encrypt3 ((DES_LONG *)tin,ks1,ks2,ks3);
tout0=tin [0];
tout1=tin [1];
12c (tout0 ,out);
12c (tout1 ,out);

}

iv = &(*ivec) [0];
12c (tout0, iv);
12c (tout1, iv);

}
else
{

register DES_LONG t0,t1;
c21 (iv,xor0);
c21 (iv,xor1);
for (1−=8; 1>=0 1−=8)
{
c21 (in,tin0);
c21 (in,tin1);
t0=tin0;
t1=tin1;
tin[0]=tin0;
tin[1]=tin1;
des_decrypt3((DES_LONG *)tin,ks1,ks2,ks3);
tout0=tin[0];
tout1=tin[1];
tout0ˆ =xor0;
tout1ˆ =xor1;
12c(tout0,out);
12c(tout1,out);
xor0=t0;
xor1=t1;

}

if (1 != −8)
{
c21(in,tin0);
c21(in,tin1);
t0=tin0;
t1=tin1;
tin[0]=tin0;
tin[1]=tin1;
des_decrypt3((DES_LONG *)tin,ks1,ks2,ks3);
tout0=tin[0];
tout1=tin[1];
tout0ˆ =xor0;
tout1ˆ =xor1;
12cn(tout0,tout1,out,1+8);
xor0=t0;
xor1=t1;
}
iv = &(*ivec) [0];
12c(xor0,iv);
12c(xor1,iv);

```
  }
  tin0=tin1=tout0=tout1=xor0=xor1=0;
  tin[0]=tin[1]=0;
}
```

As an option, a RC1000-PP Support Library may be installed utilizing supplied documentation that accompanies the support library.

A new configuration script should be created for OpenSSL that includes the RC1000-PP library. Table 3 illustrates possible configuration options.

TABLE 3
sh config no-idea -fPIC no-asm −1pp1000

The Apache configuration script should be altered to include the RC1000-PP support library. This can be done by editing the file “apache_x.x.x/src/configure.tmpl.” The line “EXTRA_LIBS=” should be change to “EXTRA_LIBS=pp1000.” The whole Apache project, including OpenSSL, may then be re-compiled. To start the Apache web server, the well known “-X-DSSL” command line options should be used.

To this end, the encryption layer module offloads a host processor of the server by executing the selected encryption algorithm using programmable encrypter hardware. Note operation 304 of FIG. 3. Further, the server is capable of handling more secure connections utilizing the network 204 than would otherwise be possible. Note operation 306.

It should be noted that a re-programmable device may also be used in the context of the present invention. Such a device may be programmed at installation to load an encryption algorithm that complied with local law or met customer preferences. Further, such device may be programmed and/or re-programmed to update the hardware, error correction, or encryption algorithm. Such re-programmability may be done in a dynamic fashion to reflect changes in the operating environment.

It should be noted that the selection of the encryption algorithm may be selected based on various parameters. For example, the encryption algorithm may be selected in accordance with a current or projected load of the system, and/or a capacity of any particular communication mediums coupled to other resources. Further, the selection of the encryption algorithm may be based on a parameter of a system of which the server is a component, i.e. network, etc.

As mentioned earlier, the encryption layer module may include OpenSSL source code. Below is additional information regarding SSL and OpenSSL. Originally developed by Netscape®, SSL has been universally accepted on the World Wide Web for authenticated and encrypted communication between clients and servers.

The Transmission Control Protocol/Internet Protocol (TCP/IP) governs the transport and routing of data over the Internet. Other protocols, such as the HyperText Transport Protocol (HTTP), Lightweight Directory Access Protocol (LDAP), or Internet Messaging Access Protocol (IMAP), run “on top of” TCP/IP in the sense that they all use TCP/IP to support typical application tasks such as displaying web pages or running email servers.

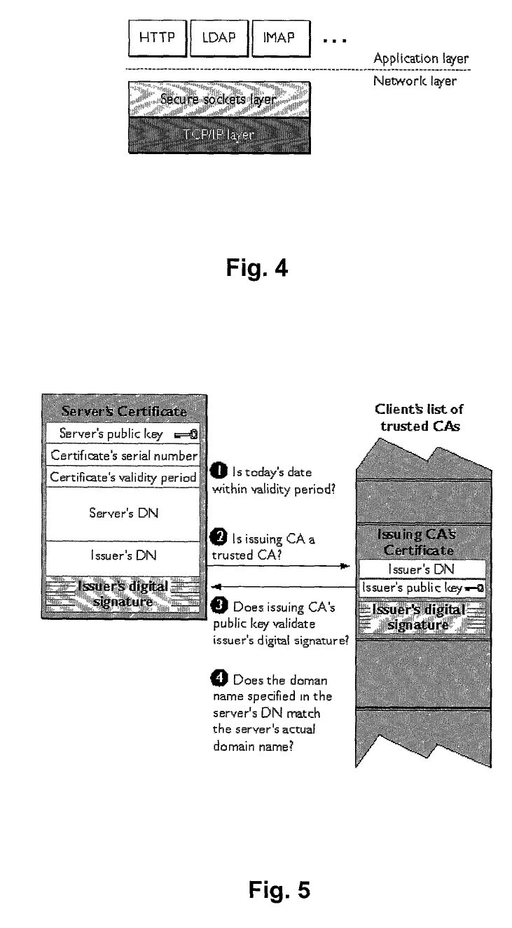

FIG. 4 shows that SSL runs above TCP/IP and below high-level application protocols. The SSL protocol runs above TCP/IP and below higher-level protocols such as HTTP or IMAP. It uses TCP/IP on behalf of the higher-level protocols, and in the process allows an SSL-enabled server to authenticate itself to an SSL-enabled client, allows the client to authenticate itself to the server, and allows both machines to establish an encrypted connection. These capabilities address fundamental concerns about communication over the Internet and other TCP/IP networks.

SSL server authentication allows a user to confirm a server's identity. SSL-enabled client software can use standard techniques of public-key cryptography to check that a server's certificate and public ID are valid and have been issued by a certificate authority (CA) listed in the client's list of trusted CAs. This confirmation might be important if the user, for example, is sending a credit card number over the network and wants to check the receiving server's identity.

SSL client authentication allows a server to confirm a user's identity. Using the same techniques as those used for server authentication, SSL-enabled server software can check that a client's certificate and public ID are valid and have been issued by a certificate authority (CA) listed in the server's list of trusted CAs. This confirmation might be important if the server, for example, is a bank sending confidential financial information to a customer and wants to check the recipient's identity.

An encrypted SSL connection requires all information sent between a client and a server to be encrypted by the sending software and decrypted by the receiving software, thus providing a high degree of confidentiality. Confidentiality is important for both parties to any private transaction. In addition, all data sent over an encrypted SSL connection is protected with a mechanism for detecting tampering—that is, for automatically determining whether the data has been altered in transit.

The SSL protocol includes two sub-protocols: the SSL record protocol and the SSL handshake protocol. The SSL record protocol defines the format used to transmit data. The SSL handshake protocol involves using the SSL record protocol to exchange a series of messages between an SSL-enabled server and an SSL-enabled client when they first establish an SSL connection.

The SSL protocol supports the use of a variety of different cryptographic algorithms, or ciphers, for use in operations such as authenticating the server and client to each other, transmitting certificates, and establishing session keys. Clients and servers may support different cipher suites, or sets of ciphers, depending on factors such as the version of SSL they support, and company policies regarding acceptable encryption strength. Among its other functions, the SSL handshake protocol determines how the server and client negotiate which cipher suites they will use to authenticate each other, to transmit certificates, and to establish session keys.

The cipher suite descriptions that follow refer to these algorithms:

DES. Data Encryption Standard, an encryption algorithm used by the U.S. Government.

DSA. Digital Signature Algorithm, part of the digital authentication standard used by the U.S. Government.

KEA. Key Exchange Algorithm, an algorithm used for key exchange by the U.S. Government.

MD5. Message Digest algorithm developed by Rivest.

RC2 and RC4. Rivest encryption ciphers developed for RSA Data Security.

RSA. A public-key algorithm for both encryption and authentication. Developed by Rivest, Shamir, and Adleman.

RSA key exchange. A key-exchange algorithm for SSL based on the RSA algorithm.

SHA-1. Secure Hash Algorithm, a hash function used by the U.S. Government.

SKIPJACK. A classified symmetric-key algorithm implemented in FORTEZZA-compliant hardware used by the U.S. Government.

Triple-DES. DES applied three times.

Key-exchange algorithms like KEA and RSA key exchange govern the way in which the server and client determine the symmetric keys they will both use during an SSL session. The most commonly used SSL cipher suites use RSA key exchange. The SSL 2.0 and SSL 3.0 protocols support overlapping sets of cipher suites. Administrators can enable or disable any of the supported cipher suites for both clients and servers. When a particular client and server exchange information during the SSL handshake, they identify the strongest enabled cipher suites they have in common and use those for the SSL session.

Decisions about which cipher suites a particular organization decides to enable depend on trade-offs among the sensitivity of the data involved, and the speed of the cipher.

Table 4 lists the cipher suites supported by SSL that use the RSA key-exchange algorithm. Unless otherwise indicated, all ciphers listed in the table are supported by both SSL 2.0 and SSL 3.0. Cipher suites are listed from strongest to weakest; for more information about the way encryption strength is measured.

TABLE 4

| Strength category and | |
|---|---|
| recommended use | Cipher suites |
| Strongest cipher suite. Permitted for | Triple DES, which supports 168- |
| deployments within the United States | bit encryption, with SHA-1 |
| only. This cipher suite is appropriate | message authentication. Triple |
| for banks and other institutions that | DES is the strongest cipher |
| handle highly sensitive data. | supported by SSL, but it is not as |
| | fast as RC4. Triple DES uses a key |
| | three times as long as the key for |
| | standard DES. Because the key |
| | size is so large, there are |
| | more possible keys than for |
| | any other cipher-approximately |
| | 3.7* 10^{50.} Both SSL 2.0 and |
| | SSL 3.0 support this cipher suite. |
| Strong cipher suites. Permitted for | RC4 with 128-bit encryption and |
| deployments within the United States | MD5 message authentication. |
| only. These cipher suites support | Because the RC4 and RC2 ciphers |
| encryption that is strong enough for | have 128-bit encryption, they |
| most business or government needs. | are the second strongest next |
| | to Triple DES (Data Encryption |
| | Standard), with 168-bit |
| | encryption. RC4 and RC2 128-bit |
| | encryption permits approximately |
| | 3.4* 10³⁸ possible keys, |
| | making them very difficult to |
| | crack. RC4 ciphers are the fastest |
| | of the supported ciphers. |
| | Both SSL 2.0 and SSL 3.0 support |
| | this cipher suite. |
| | RC2 with 128-bit encryption and |
| | MD5 message authentication. |
| | Because the RC4 and RC2 |
| | ciphers have 128-bit encryption, |
| | they are the second strongest next |
| | to Triple DES (Data Encryption |
| | Standard), with 168-bit |
| | encryption. RC4 and RC2 128-bit |
| | encryption permits approximately |
| | 3.4* 10³⁸ possible keys, making |
| | them very difficult to crack. |
| | RC2 ciphers are slower than RC4 |
| | ciphers. |
| | This cipher suite is supported by |
| | SSL 2.0 but not by SSL 3.0. |
| | DES, which supports 56-bit |
| | encryption, with SHA-1 |
| | message authentication. DES |
| | is stronger than 40-bit encryption, |
| | but not as strong as 128-bit |
| | encryption. DES 56-bit |
| | encryption permits approximately |
| | 7.2* 10¹⁶ possible keys. |
| | Both SSL 2.0 and 3.0 support this |
| | cipher suite, except that SSL 2.0 |
| | uses MD5 rather than SHA-1 |
| | for message authentication. |
| Intermediate cipher suites. These | RC4 with 40-bit encryption and |
| cipher suites are not as strong as | MD5 message authentication. |
| those listed above. | RC4 40-bit encryption permits |
| | approximately 1.1* 10^{12 (a} |
| | trillion) possible keys. RC4 |
| | ciphers are the fastest of the |
| | support this cipher. Both SSL 2.0 |
| | and SSL 3.0 support this cipher. |
| | RC2 with 40-bit encryption and |
| | MD5 message authentication. RC2 |
| | 40-bit encryption permits |
| | approximately 1.1* 10^{12 (a} |
| | trillion) possible keys. RC2 ciphers |
| | are slower than the RC4 ciphers. |
| | Both SSL 2.0 and SSL 3.0 support |
| | this cipher. |
| Weakest cipher suite. This cipher | No encryption, MD5 message |
| suite provides authentication and | authentication only. This cipher |
| tamper detection but no encryption. | suite uses MD5 message |
| Server administrators must be careful | authentication to detect tampering. |
| about enabling it, however, because | It is typically supported in case |
| data sent using this cipher suite is | a client and server have none of |
| not encrypted and may be accessed | the other ciphers in common. This |
| by eavesdroppers. | cipher suite is supported by SSL |
| | 3.0 but not by SSL 2.0. |

¹Note that for RC4 and RC2 ciphers, the phrase “40-bit encryption” means the keys are still 128 bits long, but only 40 bits have cryptographic significance.

FORTEZZA Cipher Suites

Table 5 lists additional cipher suites supported by Netscape® products with FORTEZZA for SSL 3.0. FORTEZZA is an encryption system used by U.S. government agencies to manage sensitive but unclassified information. It provides a hardware implementation of two classified ciphers developed by the federal government: FORTEZZA KEA and SKIPJACK. FORTEZZA ciphers for SSL use the Key Exchange Algorithm (KEA) instead of the RSA key-exchange algorithm mentioned in the preceding section, and use FORTEZZA cards and DSA for client authentication.

TABLE 5

| Strength category and | |
|---|---|
| recommended use | Cipher suites |
| Strong FORTEZZA cipher suites. | RC4 with 128-bit encryption and |
| Permitted for deployments within the | SHA-1 message authentication. |
| United States only. These cipher | Like RC4 with 128-bit encryption |
| suites support encryption that is | and MD5 message authentication, |
| strong enough for most business or | this cipher is one of the second |
| government needs. | strongest ciphers after Triple DES. |
| | It permits approximately 3.4* 10³⁸ |
| | possible keys, making it very |
| | difficult to crack. This cipher |
| | suite is supported by SSL 3.0 |
| | but not by SSL 2.0. |
| | RC4 with SKIPJACK 80-bit |
| | encryption and SHA-1 message |
| | authentication. The SKIPJACK |
| | cipher is a classified |
| | symmetric-key cryptographic |
| | algorithm implemented in |
| | FORTEZZA-compliant hard- |
| | ware. Some SKIPJACK |
| | implementations support key |
| | escrow using the Law Enforce- |
| | ment Access Field (LEAF). |
| | The most recent implementations |
| | do not. |
| | This cipher suite is supported by |
| | SSL 3.0 but not by SSL 2.0. |
| Weakest FORTEZZA cipher suite. | No encryption, SHA-1 message |
| This cipher suite provides | authentication only. This cipher |
| authentication and tamper detection | uses SHA-1 message |
| but no encryption. Server | authentication to detect tampering. |
| administrators must be careful about | This cipher suite is supported by |
| enabling it, however, because data | SSL 3.0 but not by SSL 2.0. |
| sent using this cipher suite is not | |
| encrypted and may be accessed by | |
| eavesdroppers. | |

The SSL Handshake

The SSL protocol uses a combination of public-key and symmetric key encryption. Symmetric key encryption is much faster than public-key encryption, but public-key encryption provides better authentication techniques. An SSL session always begins with an exchange of messages called the SSL handshake. The handshake allows the server to authenticate itself to the client using public-key techniques, then allows the client and the server to cooperate in the creation of symmetric keys used for rapid encryption, decryption, and tamper detection during the session that follows. Optionally, the handshake also allows the client to authenticate itself to the server. The exact programmatic details of the messages exchanged during the SSL handshake are beyond the scope of this document. However, the steps involved can be summarized as follows.

Step 1

The client sends the server the client's SSL version number, cipher settings, randomly generated data, and other information the server needs to communicate with the client using SSL.

Step 2

The server sends the client the server's SSL version number, cipher settings, randomly generated data, and other information the client needs to communicate with the server over SSL. The server also sends its own certificate and, if the client is requesting a server resource that requires client authentication, requests the client's certificate.

Step 3

The client uses some of the information sent by the server to authenticate the server. If the server cannot be authenticated, the user is warned of the problem and informed that an encrypted and authenticated connection cannot be established. If the server can be successfully authenticated, the client goes on to Step 4.

Step 4

Using all data generated in the handshake so far, the client (with the cooperation of the server, depending on the cipher being used) creates the premaster secret for the session, encrypts it with the server's public key (obtained from the server's certificate, sent in Step 2 above), and sends the encrypted premaster secret to the server.

Step 5

If the server has requested client authentication (an optional step in the handshake), the client also signs another piece of data that is unique to this handshake and known by both the client and server. In this case the client sends both the signed data and the client's own certificate to the server along with the encrypted premaster secret. If the server has requested client authentication, the server attempts to authenticate the client. If the client cannot be authenticated, the session is terminated. If the client can be successfully authenticated, the server uses its private key to decrypt the premaster secret, then performs a series of steps (which the client also performs, starting from the same premaster secret) to generate the master secret.

Step 6

Both the client and the server use the master secret to generate the session keys, which are symmetric keys used to encrypt and decrypt information exchanged during the SSL session and to verify its integrity—that is, to detect any changes in the data between the time it was sent and the time it is received over the SSL connection.

Step 7

The client sends a message to the server informing it that future messages from the client will be encrypted with the session key. It then sends a separate (encrypted) message indicating that the client portion of the handshake is finished. The server sends a message to the client informing it that future messages from the server will be encrypted with the session key. It then sends a separate (encrypted) message indicating that the server portion of the handshake is finished.

The SSL handshake is now complete, and the SSL session has begun. The client and the server use the session keys to encrypt and decrypt the data they send to each other and to validate its integrity.

Before continuing with the session, Netscape servers can be configured to check that the client's certificate is present in the user's entry in an LDAP directory. This configuration option provides one way of ensuring that the client's certificate has not been revoked.

It's important to note that both client and server authentication involve encrypting some piece of data with one key of a public-private key pair and decrypting it with the other key:

In the case of server authentication, the client encrypts the premaster secret with the server's public key. Only the corresponding private key can correctly decrypt the secret, so the client has some assurance that the identity associated with the public key is in fact the server with which the client is connected. Otherwise, the server cannot decrypt the premaster secret and cannot generate the symmetric keys required for the session, and the session will be terminated.

In the case of client authentication, the client encrypts some random data with the client's private key—that is, it creates a digital signature. The public key in the client's certificate can correctly validate the digital signature only if the corresponding private key was used. Otherwise, the server cannot validate the digital signature and the session is terminated.

The sections that follow provide more details on Server Authentication and Client Authentication.

Server Authentication

Netscape's SSL-enabled client software always requires server authentication, or cryptographic validation by a client of the server's identity. As explained in Step 2 above, the server sends the client a certificate to authenticate itself. The client uses the certificate in Step 3 above to authenticate the identity the certificate claims to represent.

To authenticate the binding between a public key and the server identified by the certificate that contains the public key, an SSL-enabled client must receive a “yes” answer to the four questions shown in FIG. 5. Although the fourth question is not technically part of the SSL protocol, it is the client's responsibility to support this requirement, which provides some assurance of the server's identity and thus helps protect against a form of security attack known as “man in the middle.”

FIG. 5 illustrates how a server authenticates a server's identity:

Is today's date within the validity period? The client checks the server certificate's validity period. If the current date and time are outside of that range, the authentication process won't go any further. If the current date and time are within the certificate's validity period, the client goes on to Step 2 of FIG. 5.

Is the issuing CA a trusted CA? Each SSL-enabled client maintains a list of trusted CA certificates, represented by the shaded area on the right side of FIG. 5. This list determines which server certificates the client will accept. If the distinguished name (DN) of the issuing CA matches the DN of a CA on the client's list of trusted CAs, the answer to this question is yes, and the client goes on to Step 3 of FIG. 5. If the issuing CA is not on the list, the server will not be authenticated unless the client can verify a certificate chain ending in a CA that is on the list.

Does the issuing CA's public key validate the issuer's digital signature? The client uses the public key from the CA's certificate (which it found in its list of trusted CAs in step 2 of FIG. 5) to validate the CA's digital signature on the server certificate being presented. If the information in the server certificate has changed since it was signed by the CA or if the CA certificate's public key doesn't correspond to the private key used by the CA to sign the server certificate, the client won't authenticate the server's identity. If the CA's digital signature can be validated, the server treats the user's certificate as a valid “letter of introduction” from that CA and proceeds. At this point, the client has determined that the server certificate is valid. It is the client's responsibility to take Step 4 before Step 5 of FIG. 5.

Does the domain name in the server's certificate match the domain name of the server itself? This step confirms that the server is actually located at the same network address specified by the domain name in the server certificate. Although Step 4 is not technically part of the SSL protocol, it provides the only protection against a form of security attack known as a Man-in-the-Middle Attack. Clients must perform this step and must refuse to authenticate the server or establish a connection if the domain names don't match. If the server's actual domain name matches the domain name in the server certificate, the client goes on to Step 5 of FIG. 5.

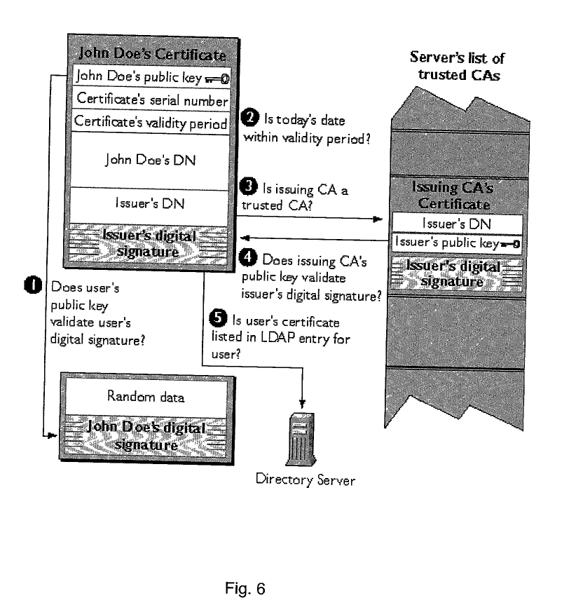

The server is authenticated. (Step 5) The client proceeds with the SSL handshake. If the client doesn't get to step 5 for any reason, the server identified by the certificate cannot be authenticated, and the user will be warned of the problem and informed that an encrypted and authenticated connection cannot be established. If the server requires client authentication, the server performs the steps described below during reference to FIG. 6.

After the steps described here, the server must successfully use its private key to decrypt the premaster secret the client sends in Step 4 of FIG. 5. Otherwise, the SSL session will be terminated. This provides additional assurance that the identity associated with the public key in the server's certificate is in fact the server with which the client is connected.

Man-in-the-Middle Attack

As suggested in Step 4 of FIG. 5 above, the client application must check the server domain name specified in the server certificate against the actual domain name of the server with which the client is attempting to communicate. This step is necessary to protect against a man-in the middle attack, which works as follows. The “man in the middle” is a rogue program that intercepts all communication between the client and a server with which the client is attempting to communicate via SSL. The rogue program intercepts the legitimate keys that are passed back and forth during the SSL handshake, substitutes its own, and makes it appear to the client that it is the server, and to the server that it is the client.

The encrypted information exchanged at the beginning of the SSL handshake is actually encrypted with the rogue program's public key or private key, rather than the client's or server's real keys. The rogue program ends up establishing one set of session keys for use with the real server, and a different set of session keys for use with the client. This allows the rogue program not only to read all the data that flows between the client and the real server, but also to change the data without being detected. Therefore, it is extremely important for the client to check that the domain name in the server certificate corresponds to the domain name of the server with which a client is attempting to communicate—in addition to checking the validity of the certificate by performing the other steps described in during reference to FIG. 6 below.

Client Authentication

SSL-enabled servers can be configured to require client authentication, or cryptographic validation by the server of the client's identity. When a server configured this way requests client authentication, the client sends the server both a certificate and a separate piece of digitally signed data to authenticate itself. The server uses the digitally signed data to validate the public key in the certificate and to authenticate the identity the certificate claims to represent.

The SSL protocol requires the client to create a digital signature by creating a one-way hash from data generated randomly during the handshake and known only to the client and server. The hash of the data is then encrypted with the private key that corresponds to the public key in the certificate being presented to the server. To authenticate the binding between the public key and the person or other entity identified by the certificate that contains the public key, an SSL-enabled server must receive a “yes” answer to the first four questions shown in FIG. 5. Although the fifth question is not part of the SSL protocol, Netscape servers can be configured to support this requirement to take advantage of the user's entry in an LDAP directory as part of the authentication process.

FIG. 6 illustrates how a server authenticates a client certificate. As shown, an SSL-enabled server goes through the following steps to authenticate a user's identity:

Does the user's public key validate the user's digital signature? The server checks that the user's digital signature can be validated with the public key in the certificate. If so, the server has established that the public key asserted to belong to John Doe matches the private key used to create the signature and that the data has not been tampered with since it was signed.

At this point, however, the binding between the public key and the DN specified in the certificate has not yet been established. The certificate might have been created by someone attempting to impersonate the user. To validate the binding between the public key and the DN, the server must also complete Step 3 and Step 4 of FIG. 6.

Is today's date within the validity period? The server checks the certificate's validity period. If the current date and time are outside of that range, the authentication process won't go any further. If the current date and time are within the certificate's validity period, the server goes on to Step 3 of FIG. 6.

Is the issuing CA a trusted CA? Each SSL-enabled server maintains a list of trusted CA certificates, represented by the shaded area on the right side of FIG. 6. This list determines which certificates the server will accept. If the DN of the issuing CA matches the DN of a CA on the server's list of trusted CAs, the answer to this question is yes, and the server goes on to Step 4 of FIG. 6. If the issuing CA is not on the list, the client will not be authenticated unless the server can verify a certificate chain ending in a CA that is on the list. Administrators can control which certificates are trusted or not trusted within their organizations by controlling the lists of CA certificates maintained by clients and servers.

Does the issuing CA's public key validate the issuer's digital signature? The server uses the public key from the CA's certificate (which it found in its list of trusted CAs in Step 3 of FIG. 6) to validate the CA's digital signature on the certificate being presented. If the information in the certificate has changed since it was signed by the CA or if the public key in the CA certificate doesn't correspond to the private key used by the CA to sign the certificate, the server won't authenticate the user's identity. If the CA's digital signature can be validated, the server treats the user's certificate as a valid “letter of introduction” from that CA and proceeds. At this point, the SSL protocol allows the server to consider the client authenticated and proceed with the connection as described in Step 6 of FIG. 6. Netscape servers may optionally be configured to take Step 5 before Step 6 of FIG. 6.

Is the user's certificate listed in the LDAP entry for the user? This optional step provides one way for a system administrator to revoke a user's certificate even if it passes the tests in all the other steps. The Netscape Certificate Server can automatically remove a revoked certificate from the user's entry in the LDAP directory. All servers that are set up to perform this step will then refuse to authenticate that certificate or establish a connection. If the user's certificate in the directory is identical to the user's certificate presented in the SSL handshake, the server goes on to step 6 of FIG. 6.

Is the authenticated client authorized to access the requested resources? (Step 6) The server checks what resources the client is permitted to access according to the server's access control lists (ACLs) and establishes a connection with appropriate access. If the server doesn't get to Step 6 for any reason, the user identified by the certificate cannot be authenticated, and the user is not allowed to access any server resources that require authentication.

OpenSSLL

OpenSSL is a cryptography toolkit implementing the Secure Sockets Layer (SSL v2/v3) and Transport Layer Security (TLS v1) network protocols and related cryptography standards required by them. The OpenSSL program is a command line tool for using the various cryptography functions of OpenSSL's crypto library from the shell. It can be used for:

Creation of RSA, DH and DSA key parameters

Creation of X.509 certificates, CSRs and CRLs

Calculation of Message Digests

Encryption and Decryption with Ciphers

SSL/TLS Client and Server Tests

Handling of S/MIME signed or encrypted mail

The OpenSSL program provides a rich variety of commands each of which often has a wealth of options and arguments.

Alternate Encryption Schemes

Additional encryption schemes will now be set forth from which the user may select. For example, a public key/private key encryption system is described in Ganesan, Yaksha, An Improved System And Method For Securing Communications Using Split Private Key Asymmetric Cryptography, U.S. Pat. No. 5,535,276 Jul. 9, 1996). In Torii, Key Distribution Protocol For File Transfer In The Local Area Network, U.S. Pat. No. 5,313,521 May 17, 1991) a key distribution center is used to authenticate a terminal to a server. Pastor, Reliable Document Authentication System, U.S. Pat. No. 4,853,961 (Aug. 1, 1989) describes a document authentication system that includes a decryption key. Choudhury, et al, Method of Protecting Electronically Published Materials Using Cryptographic Protocols, U.S. Pat. No. 5,509,074 (Apr. 16, 1996) teaches a document protection system that includes a server-to-server security access operation to authenticate each document request. Another encryption scheme, digital envelopes, is not subject to the disadvantages of secret key and public key encryption. Using digital envelopes, a sender encrypts a document with a secret key. The secret key is then encrypted with a public key. The recipient of the document then uses the recipient's private key to decrypt the secret key, and then the secret key to decrypt the document.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for utilizing encrypter hardware with a server, comprising the steps of:
(a) providing an encryption layer module run on a server, the encryption layer module capable of selecting an encryption algorithm from a library of encryption algorithms;
(b) wherein the encryption layer module offloads a host processor of the server by executing the selected encryption algorithm using dedicated encrypter hardware.

2. A method as recited in claim 1, wherein the selection of the encryption algorithm is based on a parameter of a system of which the server is a component.

3. A method as recited in claim 1, wherein the selection of the encryption algorithm is based on a parameter of the server.

4. A method as recited in claim 3, wherein the parameter includes a load.

5. A method as recited in claim 1, wherein the library is stored in a database networked to the server.

6. A method as recited in claim 1, wherein the encrypter hardware allows the server to handle more secure connections utilizing a network.

7. A computer program product for utilizing encrypter hardware with a server, comprising:
(a) computer code for providing an encryption layer module run on a server, the encryption layer module capable of selecting an encryption algorithm from a library of encryption algorithms;
(b) wherein the encryption layer module offloads a host processor of the server by executing the selected encryption algorithm using dedicated encrypter hardware.

8. A computer program product as recited in claim 7, wherein the selection of the encryption algorithm is based on a parameter of a system of which the server is a component.

9. A computer program product as recited in claim 7, wherein the selection of the encryption algorithm is based on a parameter of the server.

10. A computer program product as recited in claim 9, wherein the parameter includes a load.

11. A computer program product as recited in claim 7, wherein the library is stored in a database networked to the server.

12. A computer program product as recited in claim 7, wherein the encrypter hardware allows the server to handle more secure connections utilizing a network.

13. A system for utilizing encrypter hardware with a server, comprising the steps of:
(a) logic for providing an encryption layer module run on a server, the encryption layer module capable of selecting an encryption algorithm from a library of encryption algorithms;
(b) wherein the encryption layer module offloads a host processor of the server by executing the selected encryption algorithm using dedicated encrypter hardware.

14. A system as recited in claim 13, wherein the selection of the encryption algorithm is based on a parameter of a system of which the server is a component.

15. A system as recited in claim 13, wherein the selection of the encryption algorithm is based on a parameter of the server.

16. A system as recited in claim 15, wherein the parameter includes a load.

17. A system as recited in claim 13, wherein the library is stored in a database networked to the server.

18. A system as recited in claim 13, wherein the encrypter hardware allows the server to handle more secure connections utilizing a network.
